(19) United States
(12) Patent Application Publication
(10) Pub. No.: US 2026/0112514 A1
(43) Pub. Date: Apr. 23, 2026

(54) Method for Purifying and Recovering Medical Technetium-99m from Low Specific Activity Molybdenum-99 and System for Purifying and Recovering Medical Technetium-99m from Low Specific Activity Molybdenum-99

(71) Applicants: Chemical Design Labo. LLC, Mito-shi, Ibaraki (JP); Innovative Fuel Solutions LLC, North Las Vegas, NV (US)

(72) Inventors: Katsuyoshi TATENUMA, Mito-shi (JP); Edward MAUSOLF, North Las Vegas, NV (US); Erik V. JOHNSTONE, North Las Vegas, NV (US)

(21) Appl. No.: 19/159,535

(22) PCT Filed: Sep. 11, 2024
(86) PCT No.: PCT/JP2024/032521

§ 371 Date: Aug. 25, 2025

(30) Foreign Application Priority Data
May 7, 2024 (JP) 2024-075307
Jun. 24, 2024 (WO) PCT/JP2024/022706

(51) Int. Cl. G21G 1/00; B01D 15/00; B01J 20/08; B01J 20/20

(52) U.S. Cl. CPC G21G 1/001; B01D 15/00; B01J 20/08; B01J 20/20; G21G 2001/0042

(57) ABSTRACT

To extract, at hospitals or other use points, a radiopharmaceutical made from low-specific-activity radioactive molybdenum-99 and of radioactive technetium-99m as a raw material for a labeling compound for the radiopharmaceutical. Pack activated charcoal or alumina into a cylindrical metal mesh rather than a column, with which the flow rate is limited, in advance, adjust the molybdenum solution to a low-pH, acidic state, and then immerse the cylindrical metal mesh into the molybdenum solution while the molybdenum solution is flowing as a result of being stirred, to prepare a molybdenum-99-adsorbing column in which the molybdenum-99 has been adsorbed onto the activated charcoal or alumina, then elute the technetium-99m produced from the molybdenum-99 from the molybdenum-99-adsorbing column, and pass the eluate through a technetium-99m-purifying column packed with aluminum oxide to trap the technetium-99m, and then pass neutral-pH physiological saline through the technetium-99m-purifying column to separate and elute the technetium-99m, thereby purifying and recovering the technetium-99m while removing impurities.

### TECHNICAL FIELD

The present invention relates to processes and systems for extracting at hospitals or other use points a radiopharmaceutical made from low-specific-activity radioactive molybdenum-99 (⁹⁹Mo) and of radioactive technetium-99m (^{99m}Tc) as a raw material for a labeling compound for the radiopharmaceutical.

### BACKGROUND ART

Tc (technetium) is a transition metal with atomic number 43 positioned in group 7 and period 5. One of the isotopes of Tc, ^{99m}Tc (technetium-99m) emits only γ (gamma) rays with a short half-life (6 hours) suitable for diagnostic imaging and weak energy (140 keV) suitable for external counting and, furthermore, is produced using a generator (a ⁹⁹Mo/^{99m}TC generator) that utilizes radioactive equilibrium with ⁹⁹Mo (molybdenum-99) and is widely used in diagnostic imaging in nuclear medicine. Because of its short half-life, ^{99m}Tc is usually used by the method of first acquiring its parent nuclide, ⁹⁹Mo (a half-life of 66 hours), and then obtaining ^{99m}Tc from ⁹⁹Mo.

As a method for acquiring ⁹⁹Mo, the fission method (nuclear fission method) has been used worldwide as a practical technique, in which ⁹⁹Mo with a very high specific activity (level of radioactivity per unit mass of a substance containing a radioisotope) manufactured by utilizing a nuclear fission method by neutron irradiation of fissile uranium (²³⁵U) is produced and used after separation from the simultaneously produced nuclear fission product. In that case, the method of acquiring ^{99m}Tc by using aluminum oxide (alumina), which is commonly used for medical purposes, as an adsorbent for ⁹⁹Mo because of the high specific activity of ⁹⁹Mo, making the adsorbent hold Mo (⁹⁹Mo) up to its saturated adsorption capacity for Mo, and then eluting the daughter nuclide of ⁹⁹Mo, ^{99m}Tc, produced from the Mo (⁹⁹Mo) adsorbed on the alumina column using physiological saline (milking) has been used as an actual manufacturing technique.

Meanwhile, there is also the method of using a molybdenum compound, rather than uranium, as the starting material to obtain ⁹⁹Mo, in which the desired ⁹⁹Mo is produced by utilizing a neutron activation (n, γ) reaction (a neutron capture reaction in which a substance irradiated with neutrons n undergoes a nuclear reaction and transforms into a radioactive substance while emitting γ rays) of ⁹⁸Mo, which is contained in the molybdenum compound as one of isotopes. The ⁹⁹Mo produced in this (n, γ) method has a specific activity of approximately 1/10,000, which is extremely low compared with that in the fission method (hereinafter, low specific activity is described as LSA), which means that putting the (n, γ) method into practical use requires separating a trace amount of ^{99m}Tc as a daughter nuclide produced from a trace amount of ⁹⁹Mo included in a large amount of nonradioactive Mo and purifying and recovering the separated ^{99m}Tc.

Methods known to have previously been studied or put into practical use as (n, γ) methods include the activated charcoal method, the sol-gel method, the MEK method, and the sublimation method. In these methods, a large amount of ^{99m}TC is extracted from a large amount of ⁹⁹Mo at a pharmaceutical manufacturing facility to produce a diagnostic preparation, such as a ^{99m}Tc-labeled compound. However, at use points such as hospitals, it is common to extract, recover, and use the daily required amount of ^{99m}Tc for one or a few patients.

Although there have been many developments of portable ^{99m}Tc generators (TCPGs: technetium-99m portable generators) that use low-specific-activity (LSA) ⁹⁹Mo produced from a Mo compound, rather than high-specific-activity ⁹⁹Mo derived from uranium, they have not yet been put into practical use for the reasons described below. It should be noted that the present inventors have developed and proposed the PZC (polyzirconium compound) method, a type of sol-gel method.

In PTL 1, there are described the method and device for purifying ^{99m}Tc-recovered liquid by: producing radioactive molybdenum ⁹⁹Mo, a parent nuclide of technetium, through an (n, γ) reaction of ⁹⁸Mo by subjecting natural isotopic Mo as a starting material to neutron irradiation in a nuclear reactor; passing a Mo solution containing the ⁹⁹Mo through an activated charcoal (AC) column to make ^{99m}Tc, a daughter nuclide of ⁹⁹Mo, selectively adsorbed onto the AC to have the collection of the ^{99m}Tc; washing away non-AC-adsorbable Mo (including ⁹⁹Mo) remaining in spaces in the AC column or pores in the AC with water; then eluting ^{99m}Tc adhering to the AC from the AC using an alkali (e.g., caustic soda NaOH) solution; and further passing the Mo, ⁹⁹Mo, and radioactive and other impurities contained in the ^{99m}Tc-recovered liquid through an AL column packed with aluminum oxide (alumina) and placed after the AC column to thereby remove them.

In PTL 2, there are described the method and device for purifying ^{99m}Tc-recovered liquid by: considering the method of producing ⁹⁹Mo through an (n, γ) reaction of ⁹⁸Mo by subjecting natural isotopic Mo as a starting material to neutron irradiation in a nuclear reactor and recovering its daughter nuclide, ^{99m}Tc, using bead-shaped activated charcoal (BAC) as in PTL 1 and the method of passing a Mo solution containing ⁹⁹Mo through an AC column by pressurized flow, in which the solution is pushed into the column using a pump, or reduced-pressure flow, in which the solution is pulled into the column using a pump, in comparison with each other; then considering the method of accelerating elution by heating to approximately 80° C. as a method for washing away non-AC-adsorbable Mo (including ⁹⁹Mo) remaining in spaces in the AC column or pores in the AC with water and then eluting ^{99m}Tc adsorbed on the AC from the AC using an alkali (e.g., caustic soda NaOH) solution; and thereafter removing the Mo, ⁹⁹Mo, and radioactivated and other impurities contained in the ^{99m}Tc-recovered liquid by an AL-packed column placed after the AC column.

In PTL 3, as in PTL 1 and 2, as the method of producing ⁹⁹Mo through an (n, γ) reaction of ⁹⁸Mo by subjecting natural isotopic Mo as a starting material to neutron irradiation in a nuclear reactor, and recovering its daughter nuclide, ^{99m}Tc, using AC, there are described the method and device for purifying ^{99m}Tc-recovered liquid, wherein the recovery primarily involves using a structure in which ^{99m}Tc is selectively adsorbed and collected while radiation leakage to the outside is prevented. In this structure, a tank for the Mo solution containing ⁹⁹Mo is placed inside a double-wall cell to shield γ rays and other radiation emitted from the ⁹⁹Mo and to prevent the leakage of radioactive substances, and this tank is connected to an external cell having low radiation shielding capability and housing the AC column in it. The Mo solution is circulated in such a manner that it is routed to the AC column placed in the external cell and returns again to the internal Mo solution tank. Then non-AC-adsorbable Mo (including ⁹⁹Mo) remaining in spaces in the AC column or pores in the AC is washed away with water, and then ^{99m}Tc adsorbed on the AC is eluted from the AC using an alkali (e.g., caustic soda NaOH) solution. Lastly, the Mo, ⁹⁹Mo, and radioactive and other impurities contained in the ^{99m}Tc-recovered liquid are made to pass through an AL-packed column placed after the AC column to thereby remove them.

The PZC methods described in PTL 4 to 6 involve binding Mo including ⁹⁹Mo via Zr—O—Mo bonds using an inorganic polymer compound composed of zirconium (Zr), oxygen (O), and chlorine (Cl) (polyzirconium compound) at a proportion of 200 to 250 mg (Mo) per unit weight (g) of PZC. These methods are superior in ^{99m}Tc milking performance, which is a fundamental property of a ⁹⁹Mo-^{99m}Tc generator. However, PZC contains zirconium as a constituent thereof, so it was considered difficult to file an amendment to the Minimum Requirements for Radiopharmaceuticals and their practical application did not progress.

The same applies to PTL 7. In this case, the matrix that permits the diffusion of technetium-99m is a molybdenum compound containing molybdenum-99 selected from the group consisting of zirconium molybdate, titanium molybdate, ceric molybdate, ferric molybdate, stannic molybdate, and a mixture thereof, but all of them contain a heavy metal, such as Zr (zirconium), Ti (titanium), Ce (cerium), Fe (iron), or Sn (tin). It is thought that, for this reason, it was considered difficult to file an amendment to the Minimum Requirements for Radiopharmaceuticals and their practical application did not progress.

PTL 8 describes that using an alcohol, such as ethanol, propanol, or isopropanol, as a precipitating agent for an LSA ⁹⁹Mo solution causes 99% of it to precipitate out, facilitating the recovery of Mo (⁹⁹Mo), and also describes a method for recovering the daughter nuclide ^{99m}Tc in the solution and purifying and utilizing it. This method, however, cannot be used as a portable LSA ⁹⁹Mo/^{99m}Tc generator for quickly milking (eluting and recovering) ^{99m}Tc and its diagnostic use at hospitals or other use points.

### CITATION LIST

### Patent Literature

[PTL 1] Japanese U.S. Pat. No. 5,427,483
[PTL 2] Japanese U.S. Pat. No. 5,916,082
[PTL 3] Japanese U.S. Pat. No. 6,355,462
[PTL 4] Japanese U.S. Pat. No. 2,857,349
[PTL 5] Japanese U.S. Pat. No. 2,862,837
[PTL 6] Japanese U.S. Pat. No. 4,386,631
[PTL 7] U.S. Pat. No. 4,280,053
[PTL 8] U.S. Pat. No. 12,040,102

### SUMMARY OF INVENTION

### Technical Problem

In the known technologies described in PTL 1 to 3, in order to recover ^{99m}Tc produced in a Mo solution containing ⁹⁹Mo, AC capable of selectively adsorbing ^{99m}Tc is packed and contained inside a cylindrical metal container (column) connected to components for the Mo solution to flow in and out, and the Mo solution is passed through this column.

In the known approach, in order to completely adsorb and collect the ^{99m}Tc contained in the Mo solution by passing the solution through the AC column, it is necessary to impose a limitation on the flow rate of the Mo (⁹⁹Mo) solution (Mo solution containing ⁹⁹Mo) flowing through the flow-type AC column. Specifically, a low-specific-activity Mo solution has a low ⁹⁹Mo concentration, and thus recovering the desired amount of ^{99m}Tc from it requires passing a large volume of Mo (⁹⁹Mo) solution through the AC column. For example, when the maximum flow rate per unit time through an AC column packed with 5 g of AC is from 50 to 100 mL/min, passing 2.0 L of Mo (⁹⁹Mo) solution requires a time of 20 to 40 minutes or more. Recovering ^{99m}Tc, which has a short half-life, in a short time and using it for diagnosis, therefore, will face the challenge of operational efficiency.

However, when the volume of the Mo (⁹⁹Mo) solution is, for example, from 5 to 20 L, the time required to pass the solution through the AC column for the adsorption and collection of ^{99m}Tc is 2 to 5 hours or more, which decreases the operational efficiency, potentially causing the recovered ^{99m}Tc, which has a short half-life, to alter and turn into ^{99g}Tc, making it unusable as a pharmaceutical raw material. It should be noted that ^{99g}Tc (ground-state technetium-99) is one of the radioisotopes of Tc produced from ^{99m}Tc, has a half-life of 211,000 years, and is produced proportionally to the time elapsed after the extraction and separation of the pharmaceutical raw material ^{99m}Tc, and too large an amount of it constitutes an impurity in the pharmaceutical raw material ^{99m}TC.

To recover technetium-99m (^{99m}Tc), a daughter nuclide of radioactive molybdenum-99 (⁹⁹Mo), produced through the decay of ⁹⁹Mo from a high-concentration Mo solution containing ⁹⁹Mo as a radioactive pharmaceutical raw material, AC, where a trace amount of ^{99m}Tc can be selectively adsorbed and recovered even when Mo (⁹⁹Mo) is present at a ratio of 10¹⁶ or higher in terms of the number of atoms, can be used.

When the approach of immersing an AC-containing cylindrical metal mesh into the Mo solution and causing the surrounding Mo solution to flow by stirring it to adsorb and collect the ^{99m}Tc in the Mo solution is used as the method for selectively separating and recovering the daughter nuclide ^{99m}Tc of ⁹⁹Mo formed in the high-concentration Mo solution, there is no need to pass the solution through an AC column, which requires a limitation on the flow rate. That is, collecting the ^{99m}Tc contained in the Mo solution by adsorbing it onto AC immersed in the Mo solution eliminates the necessity of taking a long time to pass the solution through an AC column.

Furthermore, to date, ^{99m}Tc generators in which alumina supports high-specific-activity ⁹⁹Mo manufactured using enriched uranium as the starting material have been used in order to enable diagnosis by quickly milking (eluting and recovering) ^{99m}Tc at user points such as hospitals. However, the manufacture of ⁹⁹Mo, the parent nuclide of ^{99m}Tc, involves the use of enriched uranium as the starting material, raising nuclear safety concerns and the problem of high-level nuclear fission waste that is produced and accumulates during the manufacture of ⁹⁹Mo. There are also other problems including: the reliance of the ⁹⁹Mo manufacture on irradiation reactors concentrated in regions such as the EU, South Africa, and Australia; and the situation that these reactors are aging and frequently experience operational and transport issues, often interrupting the manufacture and supply of ⁹⁹Mo, resulting in difficulty in medical diagnosis with ^{99m}Tc.

In the ⁹⁸Mo (n, γ) ⁹⁹Mo reaction, in which the starting material is Mo, the radioactivity concentration of the resulting ⁹⁹Mo is 1/10,000, which is low compared with when uranium is used and is a disadvantage. For this reason, portable low-specific-activity (LSA) ⁹⁹Mo/^{99m}Tc generators for use at hospitals and other use points have not yet been put into practical application. As in the known technologies in PTL 4 to 8, the use of a heavy metal, such as Zr or Ti, as a Mo adsorbent is another reason that the practical application of known portable LSA ⁹⁹Mo/^{99m}Tc generators did not progress.

At neutral to alkaline pH, molybdate ions in an aqueous Mo solution, such as water-soluble Mo compounds like Na₂MoO₄ and (NH₄)₂MoO₄, are sparingly adsorbed onto activated charcoal, whereas Tc is adsorbed onto activated charcoal. By contrast, at low pH (e.g., in the acidic range of approximately pH 1 to 5), Mo forms a higher-order oxide structure MO₆O₂₁⁶⁻ (a type of polymeric form), and a large amount of Mo is adsorbed and retained on activated charcoal and alumina in this high-volume-density Mo oxide state.

Thus, an object of the present invention is to provide a method for extracting technetium-99m from low-specific-activity molybdenum-99 in a short time without being influenced by the volume of the molybdenum solution.

Another object of the present invention is to provide a portable generator that enables the extraction, at hospitals or other use points, of a radiopharmaceutical made from low-specific-activity radioactive molybdenum-99 and of radioactive technetium-99m as a raw material for a labeling compound for

### Solution to Problem

To solve the above problem, a method for recovering technetium-99m from low-specific-activity molybdenum-99 that is the present invention is a method of recovering the daughter nuclide technetium-99m produced through the decay of molybdenum-99 with a low specific activity contained in a high-concentration molybdenum solution by separating the technetium-99m using activated charcoal and is characterized in that the activated charcoal is packed in a cylindrical metal mesh rather than a column, with which the flow rate is limited, and immersed into the molybdenum solution while the molybdenum solution is flowing as a result of being stirred.

In the above method for recovering technetium-99m from low-specific-activity molybdenum-99, the molybdenum solution is characterized by containing radionuclide molybdenum-99 produced through a neutron capture (n, γ) reaction of natural isotopic molybdenum.

Also, a method for producing a physiological saline solution containing technetium-99m that is the present invention, is characterized by including: washing, with water, molybdenum remaining in pores in activated charcoal onto which technetium-99m recovered in the above method for recovering technetium-99m from low-specific-activity molybdenum-99 has been adsorbed; passing a solution containing the technetium-99m eluted from the activated charcoal using an alkali solution through an IER column, which is a column packed with a strongly acidic cation-exchange resin, to remove the alkali component; further passing the solution through an AL column, which is a column packed with alumina, to trap the technetium-99m; and eluting the technetium-99m from the AL column using physiological saline, thereby achieving purification as a physiological saline solution containing technetium-99m from which impurities have been removed.

In the above method for producing a physiological saline solution containing technetium-99m, the containers for housing the activated charcoal, the IER column, and the AL column are characterized by being made with an autoclavable material.

Moreover, a system for recovering technetium-99m from natural molybdenum that is the present invention is characterized by including: means for producing a high-concentration molybdenum solution containing molybdenum-99 with a low specific activity produced through a neutron capture (n, γ) reaction of natural isotopic molybdenum; means for producing the daughter nuclide technetium-99m in the molybdenum solution through the decay of the molybdenum-99; means for packing activated charcoal into a cylindrical metal mesh rather than a column, with which the flow rate is limited, and immersing the activated charcoal into the molybdenum solution while the molybdenum solution is flowing as a result of being stirred; means for washing, with water, residual molybdenum-99 away from the activated charcoal onto which the technetium-99m has been adsorbed; means for eluting the technetium-99m from the water-washed activated charcoal using an alkali solution, passing the eluate through a strongly acidic cation-exchange resin column to remove the alkali component, and then passing the resulting solution through an alumina column, thereby trapping the technetium-99m; and means for eluting the technetium-99m from the alumina column using physiological saline, thereby recovering purified technetium-99m.

To solve another of the problems described above, a method for purifying and recovering medical technetium-99m from low-specific-activity molybdenum-99 that is the present invention is a method of separating and recovering the daughter nuclide technetium-99m produced through the decay of low-specific-activity molybdenum-99 contained in a high-concentration molybdenum solution and is characterized by including: packing activated charcoal or alumina into a cylindrical metal mesh rather than a column, with which the flow rate is limited, in advance, adjusting the molybdenum solution to a low-pH, acidic state, and then immersing the cylindrical metal mesh into the molybdenum solution while the molybdenum solution is flowing as a result of being stirred, to prepare a molybdenum-99-adsorbing column in which the molybdenum-99 has been adsorbed onto the activated charcoal or alumina; eluting, from the molybdenum-99-adsorbing column, the technetium-99m produced from the molybdenum-99 and passing the eluate through a technetium-99m-purifying column packed with weakly acidic alumina to trap the technetium-99m; and passing neutral-pH physiological saline through the technetium-99m-purifying column to separate and elute the technetium-99m, thereby purifying and recovering the technetium-99m while removing impurities.

Also, a method for purifying and recovering medical technetium-99m from low-specific-activity molybdenum-99 that is the present invention is a method of separating and recovering the daughter nuclide technetium-99m produced through the decay of low-specific-activity molybdenum-99 contained in a high-concentration molybdenum solution and is characterized by including: passing the acidic molybdenum solution adjusted to a low-pH, acidic state through a column container packed with activated charcoal or alumina to prepare a molybdenum-99-adsorbing column in which the molybdenum-99 has been adsorbed onto the activated charcoal or alumina; eluting, from the molybdenum-99-adsorbing column, the technetium-99m produced from the molybdenum-99 and passing the eluate through a technetium-99m-purifying column packed with weakly acidic alumina to trap the technetium-99m; and passing neutral-pH physiological saline through the technetium-99m-purifying column to separate and elute the technetium-99m, thereby purifying and recovering the technetium-99m while removing impurities.

Also, in the above methods for purifying and recovering medical technetium-99m from low-specific-activity molybdenum-99, the molybdenum solution is characterized by containing radionuclide molybdenum-99 produced through a neutron capture (n, γ) reaction of natural isotopic molybdenum.

Also, in the above methods for purifying and recovering medical technetium-99m from low-specific-activity molybdenum-99, the methods are characterized in that the concentration of the technetium-99m separated and eluted from the molybdenum-99 is changed by increasing or reducing the amount of the activated charcoal or alumina onto which the molybdenum-99 is adsorbed according to the specific activity concentration of the molybdenum-99.

Moreover, a system for purifying and recovering medical technetium-99m from low-specific-activity molybdenum-99 that is the present invention is characterized by including: means for producing a high-concentration molybdenum solution containing low-specific-activity molybdenum-99 produced through a neutron capture (n, γ) reaction of natural isotopic molybdenum; means for preparing a molybdenum-99-adsorbing column in which the molybdenum-99 has been adsorbed onto activated charcoal or alumina after adjusting the molybdenum solution to a low-pH, acidic state; means for producing the daughter nuclide technetium-99m through the decay of the molybdenum-99; means for eluting the technetium-99m from the molybdenum-99-adsorbing column and passing the eluate through a technetium-99m-purifying column packed with weakly acidic alumina to trap the technetium-99m; and means for passing neutral-pH physiological saline through the technetium-99m-purifying column to separate and elute the technetium-99m, thereby purifying and recovering the technetium-99m while removing impurities.

Additionally, a molybdenum-99-adsorbing column that is the present invention is characterized in that, by packing activated charcoal or alumina into a cylindrical metal mesh rather than a column, with which the flow rate is limited, in advance, adjusting the molybdenum solution to a low-pH, acidic state, and then immersing the cylindrical metal mesh into the molybdenum solution while the molybdenum solution is flowing as a result of being stirred, the molybdenum-99 has been adsorbed onto the activated charcoal or alumina.

### Advantageous Effects of Invention

According to the present invention, a high-concentration Mo solution containing radioactive ⁹⁹Mo is produced, and this solution is allowed to stand for approximately 24 hours to achieve a state in which ⁹⁹Mo and ^{99m}Tc produced therefrom coexist in radioactive equilibrium (the parent and daughter nuclides are balanced at a constant ratio of radioactivity), and by immersing an AC-packed cylindrical metal mesh into the Mo solution while the solution is stirred and flowing, rather than passing the solution through an AC column as in the related art, ^{99m}Tc can be constantly trapped by adsorbing it onto the AC.

Even if the volume of the high-concentration Mo solution is, for example, as small as 0.1 L or as large as 5 to 20 L, the intended amount of ^{99m}Tc is selectively adsorbed and collected on the AC during the time it takes for ^{99m}Tc to be produced from ⁹⁹Mo and reach the radioactive equilibrium or the time until the desired amount of ^{99m}Tc is produced, which is advantageous particularly for the recovery of ^{99m}Tc, which has a short half-life (6 hours).

During the treatment for the desorption of ^{99m}Tc adsorbed and collected on the AC in the cylindrical metal mesh, non-adsorbed Mo (⁹⁹Mo) remaining in the AC is also eluted, simultaneously with the ^{99m}Tc; however, by passing the ^{99m}Tc-containing eluate through an alumina column, high-purity ^{99m}Tc can be produced and recovered as a pharmaceutical raw material without contamination by Mo (⁹⁹Mo) and other radioactive impurities.

Also, the ⁹⁹Mo manufacturing method according to the present invention uses the natural isotopic percentage of molybdenum, without using enriched uranium as the starting material. In this method, ⁹⁹Mo is produced through a neutron activation ⁹⁸Mo (n, γ) reaction of ⁹⁸Mo, an isotope of Mo present in natural molybdenum at a percentage of 24.1%.

According to the present invention, a portable generator can be provided that enables the extraction, at hospitals or other use points, of a radiopharmaceutical made from low-specific-activity radioactive molybdenum-99 and of radioactive technetium-99m as a raw material for a labeling compound for the radiopharmaceutical. Under acidic (pH 1 to 5) conditions, Mo (molybdenum-99) is adsorbed onto AC (activated charcoal) or AL (alumina) at a ratio of approximately 1 g (Mo)/5 g (AC or AL), whereas Tc (technetium-99m) is eluted without being adsorbed onto the layer of Mo (molybdenum-99) adsorbed on the AC or AL. By utilizing these characteristics, the generator serves as a practical portable LSA ⁹⁹Mo/^{99m}Tc generator (TcPG).

The practical application of portable LSA ⁹⁹Mo/^{99m}Tc generators did not progress due to the use of a heavy metal, such as Zr or Ti, as a Mo adsorbent, as well as due to the disadvantage of the ⁹⁸Mo (n, γ) ⁹⁹Mo reaction, in which the starting material is Mo, in that the radioactivity concentration of the resulting ⁹⁹Mo is extremely low compared with when uranium is used. However, in the present invention, the generator is composed of a column that adsorbs ⁹⁹Mo and an AL column that traps and concentrates ^{99m}Tc and does not use a heavy metal, so a Minor Change Notification may be sufficient for approval.

### BRIEF DESCRIPTION OF DRAWINGS

FIG. 1 is a diagram illustrating an outline of a method for extracting technetium-99m from low-specific-activity molybdenum-99 that is the present invention, a method for producing a physiological saline solution containing technetium-99m using the extraction method, and a system for recovering technetium-99m from natural molybdenum.

FIG. 2 is a diagram illustrating the known method for passing a molybdenum solution through an activated charcoal column.

FIG. 3 is a diagram illustrating the structure of a method for extracting technetium-99m from low-specific-activity molybdenum-99 that is the present invention, a method for producing a physiological saline solution containing technetium-99m using the extraction method, and a system for recovering technetium-99m from natural molybdenum. FIG. 4 is a diagram comparing the processes in a method for extracting technetium-99m from low-specific-activity molybdenum-99 that is the present invention and the processes in the known method.

FIG. 5 is a diagram illustrating process conditions for brief manufacturing in a method for producing a physiological saline solution containing technetium-99m that is the present invention.

FIG. 6 is a diagram illustrating an outline of a portable low-specific-activity molybdenum-99/technetium-99m generator in a method for purifying and recovering medical technetium-99m from low-specific-activity molybdenum-99 that is the present invention.

FIG. 7 is a diagram illustrating the process and conditions for a method for purifying and recovering medical technetium-99m from low-specific-activity molybdenum-99 that is the present invention.

FIG. 8 is a diagram illustrating a method for preparing a molybdenum-99-absorbing column in a method for purifying and recovering medical technetium-99m from low-specific-activity molybdenum-99 that is the present invention.

FIG. 9 is a diagram illustrating the equipment configuration of a portable low-specific-activity molybdenum-99/technetium-99m generator in a method for purifying and recovering medical technetium-99m from low-specific-activity molybdenum-99 that is the present invention.

FIG. 10 is a diagram illustrating the influence of pH on the adsorptivity of activated charcoal in a method for purifying and recovering medical technetium-99m from low-specific-activity molybdenum-99 that is the present invention.

FIG. 11 is a diagram illustrating the influence of pH on the adsorptivity of alumina in a method for purifying and recovering medical technetium-99m from low-specific-activity molybdenum-99 that is the present invention.

FIG. 12 show diagrams illustrating the results of a milking test of a method for purifying and recovering medical technetium-99m from low-specific-activity molybdenum-99 that is the present invention.

FIG. 13 is a diagram illustrating the results of gamma-ray measurement as a study on the radiochemical purity of technetium-99m purified and recovered by a method for purifying and recovering medical technetium-99m from low-specific-activity molybdenum-99 that is the present invention.

### DESCRIPTION OF EMBODIMENTS

Instead of recovering ^{99m}Tc by passing a Mo solution containing ⁹⁹Mo through an AC column, by keeping a cylindrical metal (e.g., stainless-steel) mesh packed with AC immersed in a ⁹⁹Mo solution tank and causing the Mo solution with the AC mesh immersed therein to flow by stirring it, maintain a state in which the AC can adsorb ^{99m}Tc constantly.

Recover high-purity ^{99m}Tc by taking the AC mesh out from the Mo solution at a predetermined or any point in time, removing non-AC-adsorbable ⁹⁹Mo remaining in pores in the AC by washing with water, and then treating the AC onto which ^{99m}Tc has been adsorbed with an alkali solution to elute the ^{99m}Tc collected by the AC and purifying this solution with a strongly acidic cation-exchange resin (IER) and alumina (AL).

Embodiments of the present invention will be described in detail with reference to drawings. It should be noted that ^{99m}Tc represents the radionuclide technetium-99m, and ⁹⁹Mo represents the radionuclide molybdenum-99. They have a relationship in which ⁹⁹Mo is the parent nuclide, whereas ^{99m}Tc is the daughter nuclide. AC stands for activated charcoal, IER stands for ion-exchange resin, and AL stands for alumina (aluminum oxide).

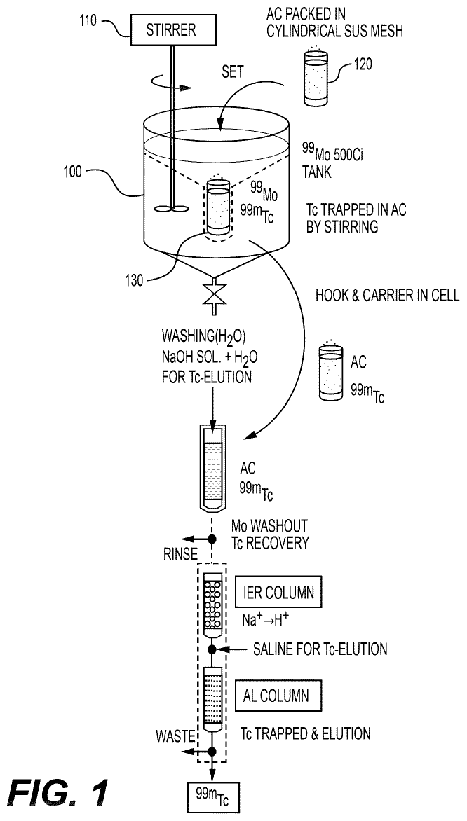

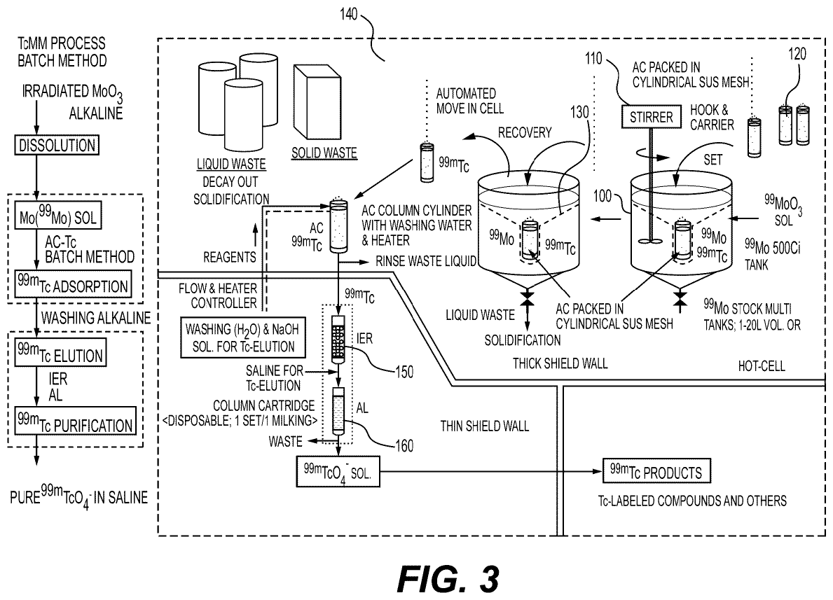

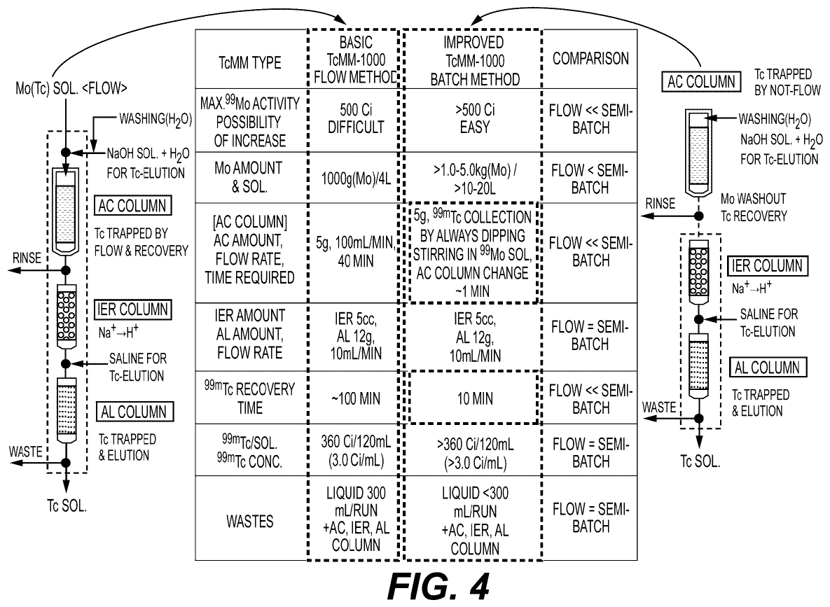

FIGS. 1 and 3 are diagrams illustrating a method for extracting technetium-99m from low-specific-activity molybdenum-99, a method for producing a physiological saline solution containing technetium-99m using the extraction method, and a system for recovering technetium-99m from natural molybdenum. Instead of the method of passing a Mo solution containing ⁹⁹Mo through an AC column, ^{99m}Tc in a Mo solution is adsorbed and collected using an AC-packed cylindrical metal mesh, through which ^{99m}Tc is purified and recovered.

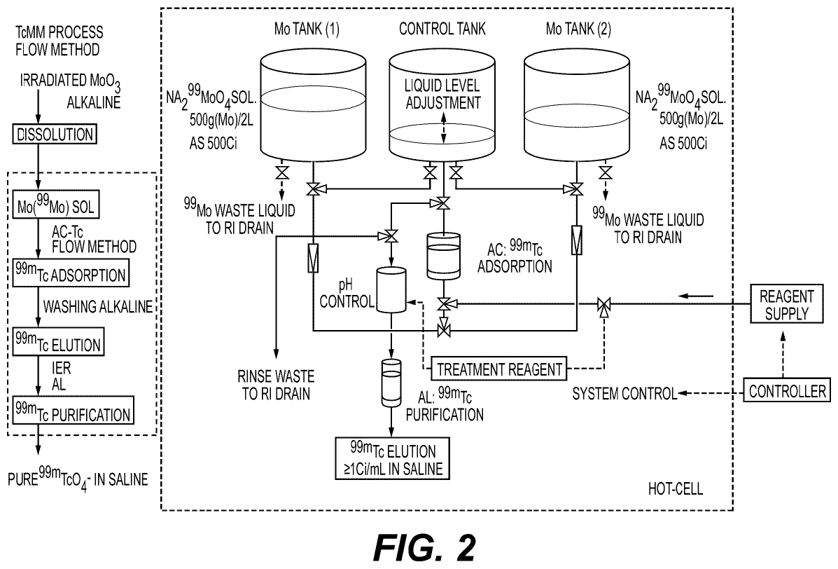

FIG. 2 is a diagram illustrating the known method, passing a molybdenum solution through an activated charcoal column.

FIG. 4 is a diagram comparing the processes in a method that is the present invention for extracting technetium-99m from low-specific-activity molybdenum-99 and in the known method.

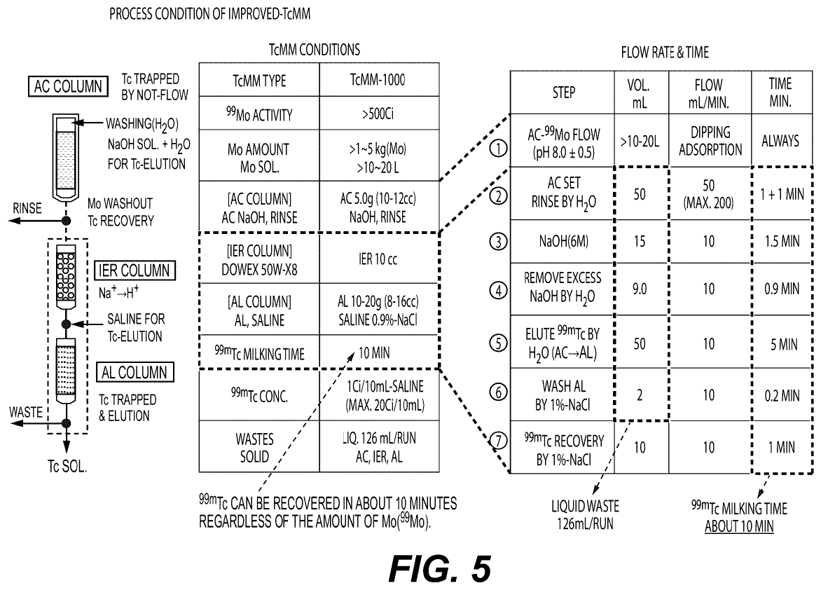

FIG. 5 is a diagram illustrating process conditions for brief manufacturing in a method for producing a physiological saline solution containing technetium-99m.

In the method for extracting technetium-99m from low-specific-activity molybdenum-99, the daughter nuclide technetium-99m produced through the decay of molybdenum-99 with a low specific activity contained in a high-concentration molybdenum solution is recovered by separating it using activated charcoal.

The activated charcoal is packed in a cylindrical metal mesh rather than a column, with which the flow rate is limited. The activated charcoal is immersed into the molybdenum solution while the solution is flowing as a result of being stirred, and selectively adsorbs a trace amount of technetium-99m in the molybdenum solution, even when molybdenum is present 1016 times or more abundantly in terms of the ratio of the number of atoms. It should be noted that the molybdenum solution contains the radionuclide molybdenum-99 produced through a neutron capture (n, γ) reaction of natural isotopic molybdenum.

In the method for producing a physiological saline solution containing technetium-99m, molybdenum remaining in pores in activated charcoal onto which technetium-99m recovered in the method for recovering technetium-99m from low-specific-activity molybdenum-99 has been adsorbed is washed with water. A solution containing the technetium-99m eluted from the activated charcoal using an alkali solution is passed through an IER column, which is a column packed with a strongly acidic cation-exchange resin, so that the alkali component will be removed. The solution is further passed through an AL column, which is a column packed with alumina, so that the technetium-99m will be trapped. The technetium-99m is eluted from the alumina column using physiological saline. As a result, purification is achieved as a physiological saline solution containing technetium-99m from which impurities have been removed.

The system for recovering technetium-99m from natural molybdenum includes means for producing a high-concentration molybdenum solution containing molybdenum-99 with a low specific activity produced through a neutron capture (n, γ) reaction of natural isotopic molybdenum; means for producing the daughter nuclide technetium-99m in the molybdenum solution through the decay of the molybdenum-99; means for packing activated charcoal into a cylindrical metal mesh rather than a column, with which the flow rate is limited, and immersing the activated charcoal into the molybdenum solution while the solution is flowing as a result of being stirred; means for washing, with water, residual molybdenum-99 away from the activated charcoal onto which the technetium-99m has been adsorbed; means for eluting the technetium-99m from the water-washed activated charcoal using an alkali solution, passing the eluate through a strongly acidic cation-exchange resin column to remove the alkali component, and then passing the resulting solution through an alumina column, thereby trapping the technetium-99m; and means for eluting the technetium-99m from the alumina column using physiological saline, thereby recovering purified technetium-99m.

### First Embodiment

As illustrated in FIG. 1, a tank 100 in which a Mo solution is stored is placed inside a hot cell, which blocks radiation, because of high radiation levels from ⁹⁹Mo. The Mo solution tank 100 includes a stirrer 110 inside it as a function of stirring the solution and also has a support 130 for holding a cylindrical metal mesh 120 with AC housed in it in the solution. A plurality of tanks 100 may be placed inside the hot cell.

To produce the radioactive pharmaceutical raw material ^{99m}Tc , an Na₂⁹⁹MOO₄ solution is supplied to the tank 100 as a Mo solution containing the radionuclide ⁹⁹Mo. Prior neutron irradiation of natural isotopic MoO₃ in a nuclear reactor produces ⁹⁹Mo. Dissolving MoO₃ containing ⁹⁹Mo with an alkali (NaOH) solution yields an Na₂⁹⁹MoO₄ solution with a neutral pH.

The Mo solution containing radioactive ⁹⁹Mo is a high-concentration Mo solution containing, for example, 500 g of Mo (750 g as MoO₃) in 2 L. To obtain approximately 500 Ci (curies) of ^{99m}Tc once, a high-concentration Mo solution containing 500 g of Mo in 2 L is required. The solution, however, may alternatively be a high-concentration Mo solution containing 50 g of Mo (75 g as MoO₃) in one-tenth the volume, i.e., 200 mL, or a large volume of high-concentration Mo solution that contains 5 kg of Mo (7.5 kg as MoO₃) in ten times the volume, i.e., 20 L.

The cylindrical metal mesh 120 with AC housed in it is placed into the tank 100 to which the Mo solution containing ⁹⁹Mo has been fed. With the metal mesh held in the Mo solution using the support 130, the Mo solution is stirred, for example using the stirrer 110 or a water flow created by a circulation pump. By maintaining this state, ^{99m}Tc produced in the Mo solution is adsorbed and collected on the AC.

Since ^{99m}Tc produced from ⁹⁹Mo reaches a radioactive equilibrium state in approximately 24 hours, the cylindrical metal mesh 120 may be pulled up from the Mo solution after waiting for this transition time or may be pulled up at a certain time before the radioactive equilibrium is reached. During the period from the immersion of the cylindrical metal mesh 120 into the Mo solution until the pulling up, the AC can be used to adsorb ^{99m}Tc .

As illustrated in FIG. 2, the known type of TcMM (technetium-99m master milker) adopts the approach of passing the entire volume of a Mo solution through an AC column to adsorb ^{99m}Tc in the Mo solution onto the AC. The AC column is a cylindrical column packed with AC, in which a liquid comes into contact with the AC while flowing through the cylinder from the inlet to the outlet. Since this approach limits the flow rate of the Mo solution through the AC column, the capacity of the AC column to process the Mo solution is therefore limited, which is disadvantageous as a technology for recovering ^{99m}Tc, whose half-life (term of existence) is short.

As illustrated in FIG. 3, the system for highly enriching and purifying and recovering ^{99m}Tc from a low-specific-activity Mo-solution is placed inside a hot cell 140, which is isolated by thick shielding walls for blocking high levels of radiation. In advance, a ⁹⁹MoO₃ solution is produced by dissolving radioactivated ⁹⁹MoO₃ with an alkali. The ⁹⁹MoO₃ solution is supplied to a plurality of storage tanks 100 with a capacity of 1 to 20 L installed inside the hot cell 140, storing a high-concentration Mo solution in which the radioactivity of ⁹⁹Mo is 500 Ci.

Cylindrical metal meshes 120 in which AC is housed and contained are placed into the tanks 100 using a hook and a carrier or the like, and held in the Mo solution containing ⁹⁹Mo with supports 130. It should be noted that the radioactive ⁹⁹Mo decays into ^{99m}Tc, through which the Mo solution turns into one that contains ^{99m}Tc.

After the cylindrical metal meshes 120 are impregnated with the Mo solution, the Mo solution can be stirred with stirrers 110 so that the Mo solution will come into contact with the AC efficiently. This results in the adsorption and collection of ^{99m}Tc produced in the Mo solution on the AC. The cylindrical metal meshes 120 are pulled up from the tanks 100, and the AC onto which ^{99m}Tc has been adsorbed is recovered. Then ⁹⁹Mo and other non-adsorbed substances remaining in the AC are removed by rinsing them away by housing the AC in a column and washing it with water.

An alkali (NaOH) solution is supplied to and passed through the AC-accommodating column while the flow rate and temperature are adjusted. The treatment with an alkali solution causes ^{99m}Tc to be eluted from the AC into the alkali solution. The alkali solution containing the released ^{99m}Tc is then passed through an IER column 150. In the IER column 150, the alkali component is trapped by a strongly acidic cation-exchange resin. The solution containing the released ^{99m}Tc is then passed through an AL column 160.

In the AL column 160, ^{99m}Tc is trapped by alumina, and impurities are released. Then physiological saline, having an NaCl concentration of 0.9% or so, is passed through the AL column 160, causing ^{99m}Tc to be eluted from the alumina into the physiological saline. The ^{99m}Tc is released in the form of a ^{99m}TCO₄ solution together with the physiological saline, and thus it is recovered as a physiological saline solution containing ^{99m}Tc purified to a high purity. The recovered ^{99m}Tc serves as a raw material for radiopharmaceuticals and labeling compounds.

As for the waste materials and waste liquids generated during the process of obtaining and recovering high-purity ^{99m}Tc from a high-concentration Mo solution, solidification and other treatments can be performed after reducing the radioactivity adhering to them to low levels through natural decay. There may be provided a space in the hot cell 140 or elsewhere for storing and containing various radioactive or nonradioactive waste materials, for example, generated in association with the treatments.

For the containers for housing the AC (the cylindrical metal meshes 120 and the AC-accommodating column for washing the AC with water in it), the IER column 150, and the AL column 160, it is preferred that their materials and contents (AC, IER, and AL) be autoclavable (121° C. and 2 atm).

As illustrated in FIG. 4, the processes in the known approach and those in the present invention are compared. The known approach is a flow-type TcMM, which adsorbs and collects ^{99m}Tc contained in a Mo solution by passing the solution through an AC column. The present invention is a batch-type, modified TcMM, which causes ^{99m}Tc produced in a Mo solution to be adsorbed onto AC by immersing a cylindrical metal mesh 120 in which the AC is housed and contained into a flowing high-concentration Mo solution, rather than passing the Mo solution through an AC column.

In the known approach, to completely adsorb and collect the ^{99m}Tc contained in the Mo solution by passing the Mo solution through the AC column, it is necessary to impose a flow-rate limitation on the AC column to allow the Mo solution to flow through it. Specifically, a low-specific-activity Mo solution has a low ⁹⁹Mo concentration, so, to recover the desired amount of ^{99m}Tc from it, it is necessary to pass a large volume of Mo solution through the AC column. For example, when the maximum flow rate per unit time through the AC column is set to 50 to 100 mL/min, passing 2.0 L of Mo solution requires a time of 20 to 40 minutes or more, which is not efficient to recover ^{99m}Tc , which has a short half-life, in a short time for diagnostic use.

Furthermore, in the case of a low-concentration Mo solution, the concentration of the resulting ^{99m}Tc is lower. The adsorption and collection of ^{99m}Tc using the AC column, therefore, requires passing a larger volume of Mo solution through the AC column. For example, when the volume of the Mo solution is from 5 to 20 L, the time required to pass the solution through the AC column is 2 to 5 hours or more, in which case the recovered ^{99m}Tc may alter and turn into ^{99g}Tc, making it unusable as a pharmaceutical raw material.

In the present invention, by contrast, the AC housed in the cylindrical metal mesh 120 is capable of selectively separating and recovering a trace amount of daughter nuclide ^{99m}Tc produced through the decay of ⁹⁹Mo in a high-concentration Mo solution containing radioactive ⁹⁹Mo, even when ⁹⁹Mo is present 10¹⁶ times or more abundantly in terms of the ratio of the number of atoms to ^{99m}Tc .

Immersing the cylindrical metal mesh 120 containing AC into the Mo solution and stirring the Mo solution to flow around the cylindrical metal mesh 120 facilitates the adsorption of ^{99m}Tc in the Mo solution onto the AC. There is no need to adjust the flow rate of the Mo solution to pass it through an AC column. Since ^{99m}Tc is constantly adsorbed onto the AC from the entire Mo solution present around the cylindrical metal mesh 120, the collection of ^{99m}Tc in a short time is possible.

As illustrated in FIG. 5, the time required for each of the steps of immersing a cylindrical metal mesh 120 in which AC is stored and contained into a Mo solution and recovering ^{99m}Tc purified as a pharmaceutical raw material from the AC onto which the ^{99m}Tc has been adsorbed and collected is significantly shortened compared with the known approach. Since the AC constantly adsorbs and collects ^{99m}Tc regardless of the volume of the Mo solution or the radioactivity of ⁹⁹Mo, the process time required for it is zero. The duration of the subsequent purification and recovery of ^{99m}Tc from the AC is approximately 10 minutes, which means that the operations can always be performed within a constant length of time and through the same process. This method, therefore, is optimum as a technology for pharmaceutical raw material manufacturing, which requires stringent quality and preparedness for shipping.

### Second Embodiment

An Mo solution (10 L) with a pH of 8 to 9 was prepared by dissolving MoO₃ (3, 750 g) containing a very large amount of Mo (2, 500 g) in a 6 M (molarity, mol/L) NaOH (1.75 to 1.8 L) solution and then adding H₂O. This Mo solution was placed into a beaker with a capacity of 15 L, and 0.1 mg of Re (rhenium) was added as an alternative element to ^{99m}Tc (500 Ci). A cylindrical metal mesh (diameter: 1.6 cm; length: 6 cm; capacity: 12 cc), which was a stainless-steel mesh, packed with AC (4.5 g) was immersed into this Mo solution and stirred by rotating the rotary blades of a stirrer in the Mo solution for 6 hours (30 rpm). After stirring, the cylindrical metal mesh was taken out from the Mo container (the container containing the Mo solution), washed with water to remove non-adsorbed Mo remaining in pores in the AC by washing them away, and the Re adsorbed on the AC was eluted from the AC with a 1.3 M NaOH solution (30 mL). The eluate was passed through an IER column, packed with a strongly acidic cation-exchange resin, and then through an AL column, in which activated alumina (6 g) was stored, through which Re was trapped by adsorption onto the alumina. Twenty milliliters of physiological saline (0.9% NaCl solution) was passed through the AL column in which Re was adsorbed. In this manner, a physiological saline solution containing Re (pH: 4.8 to 5.2) was recovered.

It should be noted that the half-life of ⁹⁹Mo is 65.94 hours, and the half-life of ^{99m}Tc is 6.01 hours. The amount of ⁹⁹Mo (500 Ci) was 1.04 mg, 1/500,000 in relation to Mo (500 g), and the amount of ^{99m}Tc (500 Ci) was 0.095 mg, 1/5,000,000 in relation to Mo (500 g). At the μCi test level, the radioactivity of ⁹⁹Mo was less than 5×10⁴ Bq (becquerels), with the ratio by weight to Mo (500 g) being smaller than 6e⁻¹⁵, and the radioactivity of ^{99m}Tc was less than 6×10⁴ Bq (becquerels), with the ratio by weight to Mo (500 g) being smaller than 6e⁻¹⁶. A TcMM test consisting of a high-range (wide-range) hot run from μCi levels to 80-Ci levels and a cold run equivalent to 500 Ci (500 g or more of Mo) was performed, with the result that the coefficient of separation between Mo and Tc with Ac (selective adsorption of Tc) was 10e¹⁶ or greater.

The amount of recovered Re was from 0.092 to 0.096 mg, and the recovery rate for Re was approximately 94%. Given that the Re was equivalent to ^{99m}Tc (500 Ci), the inventors believe that the adsorption and collection of ^{99m}Tc with AC by immersing a cylindrical metal mesh packed with AC into a Mo solution would yield similar results. These results indicate that AC selectively adsorbs a trace amount of the daughter nuclide ^{99m}Tc produced through the decay of ⁹⁹Mo in a high-concentration Mo solution, even when ⁹⁹Mo is present 10¹⁶ times or more abundantly in terms of the ratio of the number of atoms to ^{99m}Tc.

According to the present invention, a high-concentration Mo solution containing radioactive ⁹⁹Mo is produced, and this solution is allowed to stand for approximately 24 hours to achieve a state in which ⁹⁹Mo and ^{99m}Tc produced therefrom coexist in radioactive equilibrium (the parent and daughter nuclides are balanced at a constant ratio of radioactivity). By immersing an AC-packed cylindrical metal mesh into the Mo solution while the solution is stirred and flowing, rather than passing the solution through an AC column as in the related art, ^{99m}Tc can be constantly trapped by adsorbing it onto the AC.

Even if the volume of the high-concentration Mo solution is, for example, as small as 0.1 L or as large as 5 to 20 L, the intended amount of ^{99m}Tc is selectively adsorbed and collected on the AC during the time it takes for ^{99m}Tc to be produced from ⁹⁹Mo and reach the radioactive equilibrium or the time until the desired amount of ^{99m}Tc is produced, which is advantageous particularly for the recovery of ^{99m}Tc, which has a short half-life (6 hours).

During the treatment for the desorption of ^{99m}Tc adsorbed and collected on the AC in the cylindrical metal mesh, non-adsorbed Mo (⁹⁹Mo) remaining in the AC is also eluted, simultaneously with the ^{99m}Tc ; however, by passing the ^{99m}Tc-containing eluate through an alumina column, high-purity ^{99m}Tc can be produced and recovered as a pharmaceutical raw material without contamination by Mo (⁹⁹Mo) and other radioactive impurities.

### Third Embodiment

The adsorptivity of Mo and Tc onto activated charcoal (AC) or aluminum oxide (alumina, AL) is influenced by pH conditions. For example, in the case of water-soluble Mo compounds, such as Na₂MoO₄ and (NH₄)₂MoO₄, their adsorption onto or desorption from AC or AL is controlled by changing the pH (from acidic to neutral or alkaline). At low pH (e.g., in the acidic range of approximately pH 1 to 5), Mo forms higher-order oxide structures (a type of polymeric form), such as MO₆O₂₁⁶⁻, and a large amount of Mo is adsorbed and retained, for example on AC or AL, in such a high-volume-density Mo oxide state.

The method for purifying and recovering medical technetium-99m from low-specific-activity molybdenum-99 uses a portable LSA ⁹⁹Mo/^{99m}Tc generator (TcPG). In the first stage of the generator, a large amount of Mo (⁹⁹Mo) is adsorbed onto AC or AL, and ^{99m}Tc generated from the Mo (⁹⁹Mo) is eluted. In the second stage, the ^{99m}Tc is purified and concentrated using AL. Also, the TcPG is constructed as a system for purifying and recovering medical technetium-99m from low-specific-activity molybdenum-99.

When a Na Mo (⁹⁹Mo) O₄ solution is brought into a low-pH state (approximately pH 1 to 5), a polymeric Mo oxide containing ⁹⁹Mo (poly-Mo (⁹⁹Mo) Oxide) is formed in the solution and is adsorbed onto AC at a ratio of approximately 0.2 g (Mo)/g (AC) or more and retained. AC or AL with this state of Mo (⁹⁹Mo) adsorbed thereon (for AC, 5 g of it; 1.0 to 1.2 g of Mo is adsorbed) is packed into a column container, and this container is washed with physiological saline (0.9% NaCl solution, pH adjusted with HCl). In this manner, a ⁹⁹Mo (molybdenum-99)-adsorbing column for milking ^{99m}Tc is prepared.

It should be noted that the column container has a structure in which particulate materials are packed in a cylindrical container or the like and then liquids introduced into it can be discharged. There are two methods for making ⁹⁹Mo adsorbed onto AC or AL: a method of immersing a cylindrical metal mesh packed with AC or AL into a Mo (⁹⁹Mo) solution and a method of passing a Mo (⁹⁹Mo) solution through a column container packed with AC or AL.

A ^{99m}Tc (technetium-99m)-purifying column that elutes ^{99m}Tc using aluminum oxide of weakly acidic type (weakly acidic alumina AL) is placed downstream of the Mo (⁹⁹Mo)-absorbing column in the first stage, forming a portable LSA ⁹⁹Mo/^{99m}Tc generator.

Methods used by portable ^{99m}Tc generators include a method of utilizing a sol-gel reaction using a heavy metal such as zirconium (Zr) or titanium (Ti), a method of using only alumina with low Mo adsorption potential but in a large amount, and a method of using mesoporous alumina (porous weakly acidic alumina), which reportedly has high Mo adsorption capability. By contrast, the method for purifying and recovering medical technetium-99m from low-specific-activity molybdenum-99 does not use dissimilar heavy metals but uses AL the light element carbon (C), both of which are used in known portable ⁹⁹Mo/^{99m}Tc generators, and is the method used by a portable LSA ⁹⁹Mo/^{99m}Tc generator that has a Mo (⁹⁹Mo) adsorption and retention capacity and the properties for eluting and recovering of high-purity ^{99m}Tc.

When the specific activity concentration of Mo (⁹⁹Mo) changes but it is desired to prepare a Mo (⁹⁹Mo)-absorbing column with AC or AL retaining an equivalent amount of ⁹⁹Mo adsorbed thereon, it is enough to change the amount of AC or AL. In this case, the ^{99m}Tc -purifying column in the second stage temporarily traps ^{99m}Tc eluted from the Mo (⁹⁹Mo)-adsorbing column, and the concentration of the recovered purified ^{99m}Tc is maintained at a substantially equivalent level, so that even if the specific activity concentration of Mo (⁹⁹Mo) changes within a certain range or the radioactivity diminishes, the performance of the ^{99m}Tc generator can be kept consistent.

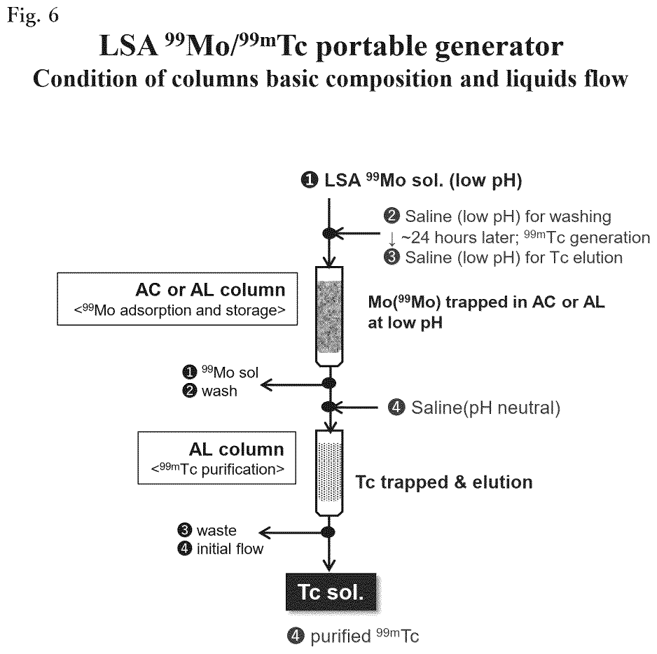

FIG. 6 is a diagram illustrating an outline of a portable low-specific-activity molybdenum-99/technetium-99m generator in a method for purifying and recovering medical technetium-99m from low-specific-activity molybdenum-99 that is the present invention.

A description will now be given of the basic structure and solution flow of a portable LSA ⁹⁹Mo/^{99m}Tc generator in which a Mo (⁹⁹Mo)-absorbing column where low-specific-activity ⁹⁹Mo is adsorbed on AC or AL is placed in the first stage and a ^{99m}Tc -purifying column that uses AL is placed in the second stage.

First, a low-pH (approximately pH 1 to 5) solution of low-specific-activity Mo (⁹⁹Mo) is passed through the Mo (⁹⁹Mo) adsorbing column. The ⁹⁹Mo is adsorbed onto the Mo (⁹⁹Mo) adsorbing column, and the discharged Mo (⁹⁹Mo) solution is removed.

Then low-pH (approximately pH 1 to 5) physiological saline is passed to wash the Mo (⁹⁹Mo)-adsorbing column. The physiological saline discharged during the washing is removed as waste liquid. Leave the column in that state for approximately 24 hours to cause part of the ⁹⁹Mo adsorbed on the Mo (⁹⁹Mo)-absorbing column to decay, producing ^{99m}Tc .

Then, low-pH (approximately pH 1 to 5) physiological saline is passed through the Mo (⁹⁹Mo)-absorbing column. This causes ^{99m}TCO₄⁻ to elute from the Mo (⁹⁹Mo)-absorbing column, so the eluate is passed through the ^{99m}Tc -purifying column. The ^{99m}TCO₄⁻ is trapped in the ^{99m}Tc -purifying column, and the discharged waste liquid is removed.

Lastly, neutral-pH physiological saline is passed through the ^{99m}Tc-purifying column. The initial eluate is removed, but then ^{99m}TCO₄⁻ elutes from the ^{99m}Tc -purifying column. It is recovered as purified ^{99m}Tc .

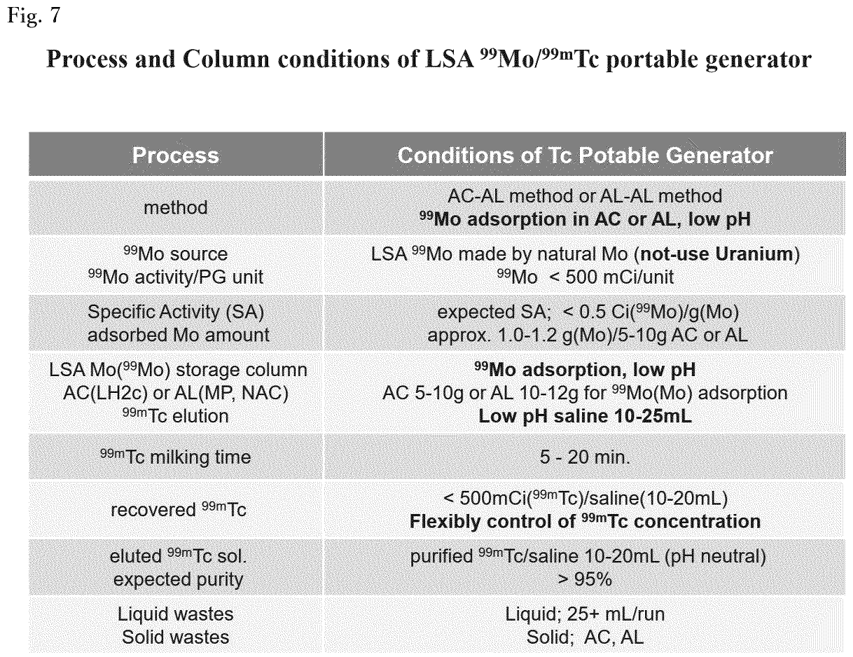

FIG. 7 is a diagram illustrating the process and conditions for a method for purifying and recovering medical technetium-99m from low-specific-activity molybdenum-99 that is the present invention.

The AC may be either coconut shell-based crushed activated charcoal or spherical activated charcoal and can be any type that has been activated to a specific surface area of 1000 m²/g or more and that contains no eluting impurities. Examples of AL include particulate mesoporous alumina, which has high Mo adsorption capability, and shaped nanoporous alumina.

The starting material for ⁹⁹Mo is low-radioactivity ⁹⁹Mo generated from natural isotopic Mo, rather than uranium. Its specific activity concentration is desirably, for example, around 0.5 Ci/g (Mo) or more.

It should be noted that, since the ^{99m}Tc-purifying column has the function of concentrating ^{99m}Tc downstream of the Mo (⁹⁹Mo)-absorbing column, even if the specific activity concentration is low (e.g., around 0.1 to 0.2 Ci/g (Mo) ), the desired concentration of high-purity ^{99m}Tc can be recovered by increasing the amount of AC or AL in the Mo (⁹⁹Mo)-absorbing column.

The amount of Mo adsorbed onto the AC or AL is preferably from approximately 1.0 to 1.2 g (Mo) /5 to 10 g (AC or AL). The Mo (⁹⁹Mo)-adsorbing column only needs to be from 5 to 10 g in the case of AC, and from 10 to 12 g in the case of AL. Milking for 5 to 20 minutes using 10 to 25 mL of low-pH physiological saline through a Mo (containing 500 mCi of ⁹⁹Mo)-absorbing column results in the elution of 500 mCi of ^{99m}Tc , but the concentration can be controlled.

When recovered at the ^{99m}Tc-purifying column, the ^{99m}Tc can be obtained with a purity of 95% or more using 10 to 25 ml of neutral-pH physiological saline. At hospitals or other use points, high-purity ^{99m}Tc for use in patient diagnosis can be obtained in a short time (around 5 to 20 minutes), and the radioactive waste generated has low levels of radioactivity and is small in amount.

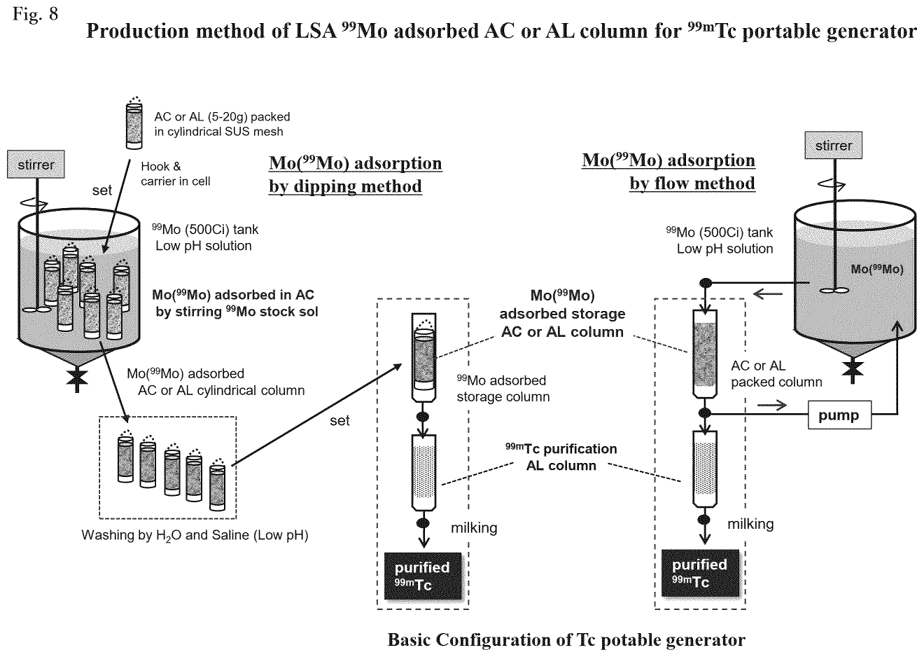

FIG. 8 is a diagram illustrating a method for preparing a molybdenum-99-adsorbing column in a method for purifying and recovering medical technetium-99m from low-specific-activity molybdenum-99 that is the present invention.

Possible methods for preparing the Mo (⁹⁹Mo)-absorbing column include the immersion method, in which a cylindrical metal mesh with built-in AC or AL is immersed into a Mo (⁹⁹Mo) solution to cause the Mo (⁹⁹Mo) to be adsorbed onto the AC or AL, and the passage method, in which a Mo (⁹⁹Mo) solution is passed through a column container packed with AC or AL to achieve adsorption of Mo (⁹⁹Mo).

Store a low-pH Mo (⁹⁹Mo) solution in a ⁹⁹Mo (500 Ci) tank in advance. Note that the tank should be equipped with a stirrer or other stirring function.

In the case of the immersion method, prepare numerous cylindrical metal meshes each composed of a cylindrical SUS mesh packed with 5 to 20 g of AC or AL, and place all of them into the Mo (⁹⁹Mo) solution at once, while the solution is flowing as a result of being stirred. Thereafter, remove the cylindrical metal meshes from the tank and wash them with low-pH H₂O and physiological saline to make them Mo (⁹⁹Mo)-adsorbing columns.

In the case of the passage method, introduce the Mo (⁹⁹Mo) solution into the column container packed with AC or AL, and return the discharged Mo (⁹⁹Mo) solution to the tank using a pump. Thereafter, the column container should be used as a Mo (⁹⁹Mo)-adsorbing column as it is.

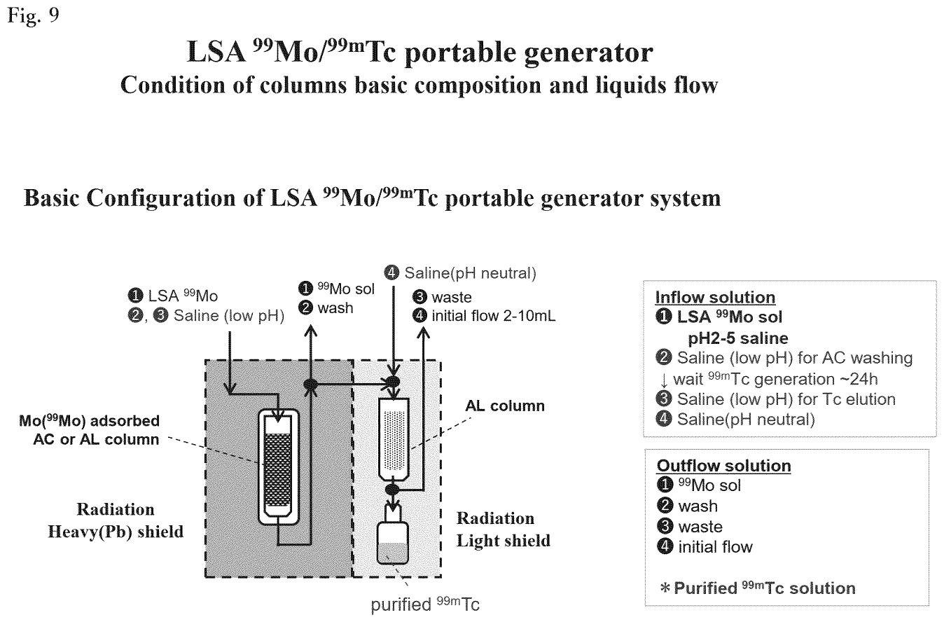

FIG. 9 is a diagram illustrating the equipment configuration of a portable low-specific-activity molybdenum-99/technetium-99m generator in a method for purifying and recovering medical technetium-99m from low-specific-activity molybdenum-99 that is the present invention.

Since external radiation (β-rays and γ-rays) is strongly emitted from the Mo (⁹⁹Mo)-adsorbing column, cover the Mo (⁹⁹Mo)-adsorbing column with a sturdy shielding material (e.g., lead or tungsten). Since ^{99m}Tc emits only relatively weak y-rays (141 KeV), the shielding material for the ^{99m}Tc-purifying column and related components may be a lightweight one.

The portable LSA ⁹⁹Mo/^{99m}Tc generator is also provided with, for example, a container for supplying eluents such as physiological saline, a container for collecting eluates such as washings separated from the flow from the Mo (⁹⁹Mo)-adsorbing column to the ^{99m}Tc -purifying column, and a container for recovering the ^{99m}Tc that has been purified by removing impurities through the ^{99m}Tc-purifying column.

Examples of eluents into the Mo (⁹⁹Mo)-absorbing column include the LSA ⁹⁹Mo solution (pH 1 to 5), physiological saline for washing (low pH), and physiological saline for elution (low pH). Examples of eluates from the Mo (⁹⁹Mo)-adsorbing column include the ⁹⁹Mo solution and washings.

Examples of eluents into the ^{99m}Tc-purifying column include physiological saline (neutral pH). Examples of eluates from the ^{99m}Tc-purifying column include the waste liquid generated when ^{99m}Tc is eluted from the Mo (⁹⁹Mo)-absorbing column and the initial eluate during the purification of ^{99m}Tc through the ^{99m}Tc-purifying column.

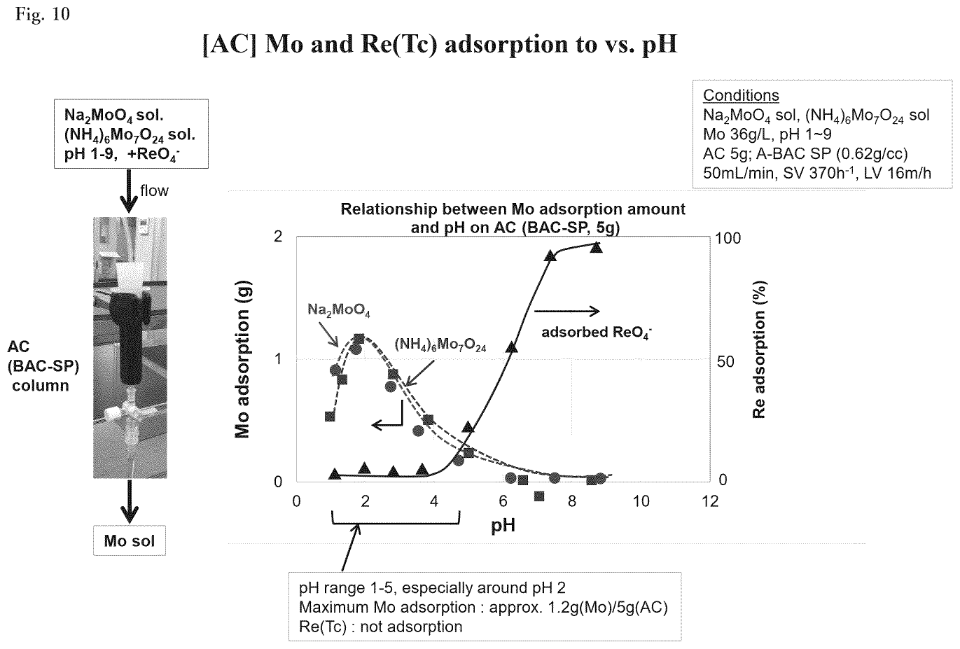

FIG. 10 is a diagram illustrating the influence of pH on the adsorptivity of activated charcoal in a method for purifying and recovering medical technetium-99m from low-specific-activity molybdenum-99 that is the present invention. It should be noted that Re (rhenium), an element in the same group as Tc, is used as an alternative to ^{99m}Tc.

At near pH 1 to 5, Mo is adsorbed at a maximum rate of 1.2 g (Mo)/5 g (AC), whereas Re is sparingly adsorbed. That is, it can be understood that Mo is strongly adsorbed onto AC at near PH 1 to 5, and Re (Tc) is not adsorbed in that pH range.

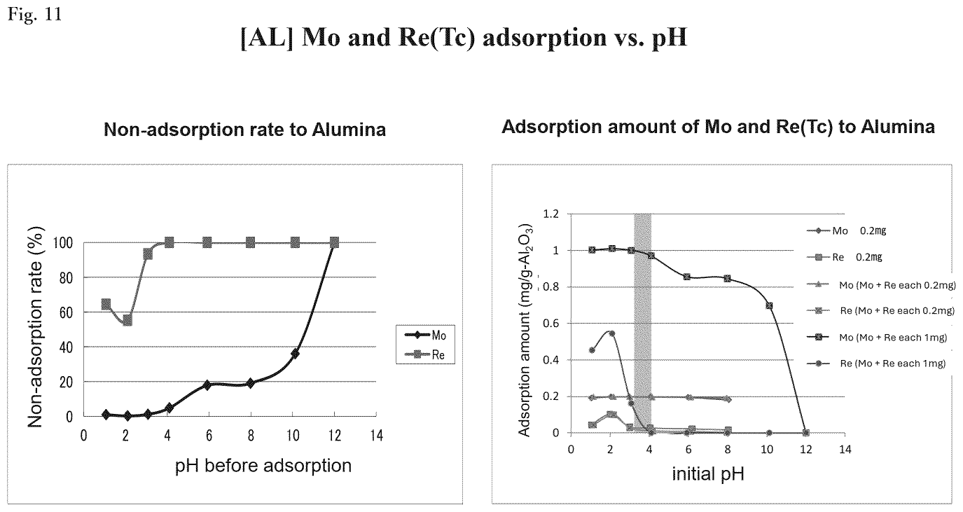

FIG. 11 is a diagram illustrating the influence of pH on the adsorptivity of alumina in a method for purifying and recovering medical technetium-99m from low-specific-activity molybdenum-99 that is the present invention. It can be understood that in the case of AL as well, the adsorption rate and amount of Mo are high at near pH 1 to 5, and the adsorption rate and amount of Re (Tc) are low in that pH range, as in the case of AC.

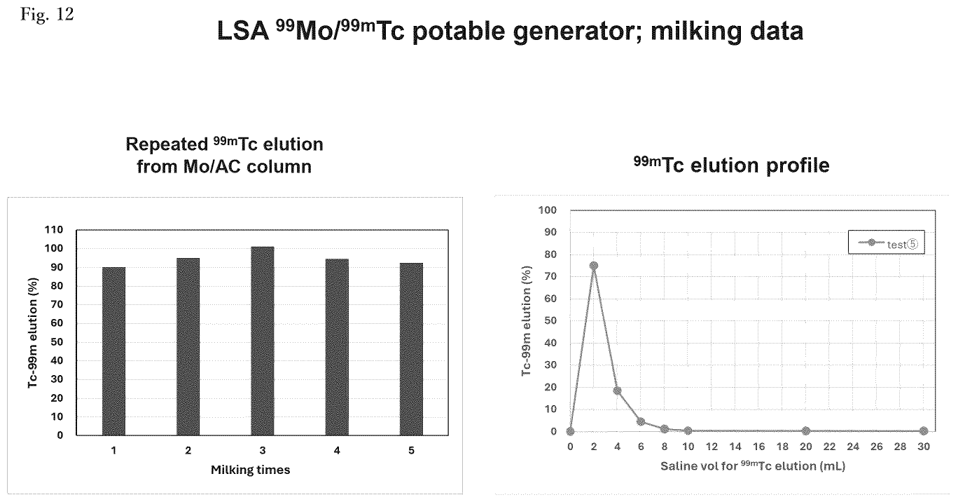

FIG. 12 shows diagrams illustrating the results of a milking test of a method for purifying and recovering medical technetium-99m from low-specific-activity molybdenum-99 that is the present invention.

As illustrated in FIG. 12 (a), when the operation of eluting ^{99m}Tc from a Mo (⁹⁹Mo)-adsorbing column was repeated once a day for five days (five times), the ^{99m}Tc elution rate was 90% or more.

As illustrated in FIG. 12 (b), when neutral-pH physiological saline (up to 30 mL) was passed through a ^{99m}Tc-purifying column, all of the ^{99m}Tc was eluted from the ^{99m}Tc-purifying column when 10 mL of physiological saline was passed.

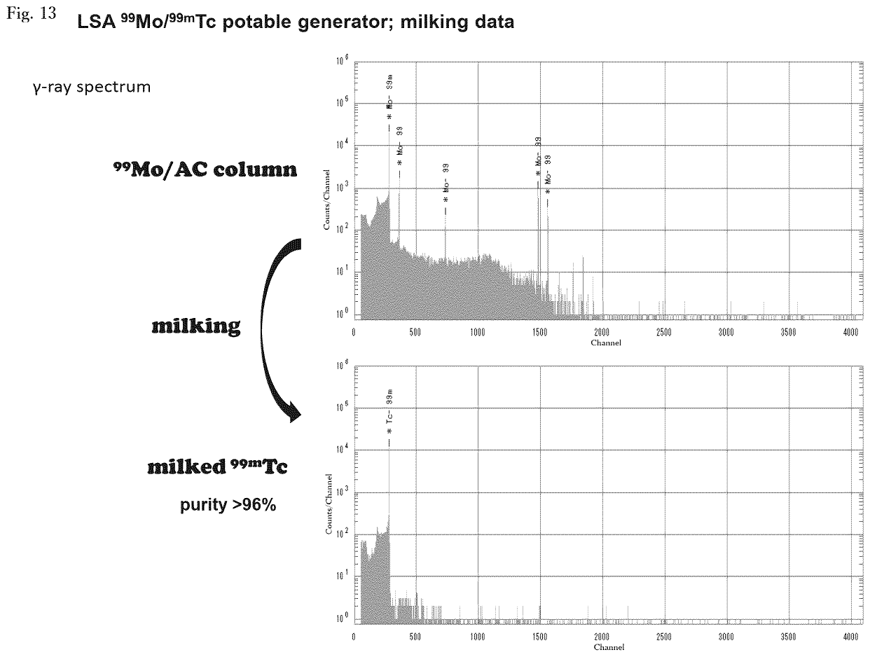

FIG. 13 is a diagram illustrating the results of gamma-ray measurement as a study on the radiochemical purity of technetium-99m purified and recovered by a method for purifying and recovering medical technetium-99m from low-specific-activity molybdenum-99 that is the present invention. Based on the γ-ray spectrum data from the Mo (⁹⁹Mo)-absorbing column and the eluted and recovered ^{99m}Tc solution, it can be understood that ^{99m}Tc with a radiochemical purity of 96% or more was recovered.

The ⁹⁹Mo manufacturing method according to the present invention is a method in which enriched uranium is not used as the starting material but the natural isotopic percentage of molybdenum is used. In this method, ⁹⁹Mo is produced through a neutron activation ⁹⁸Mo (n, γ) reaction of ⁹⁸Mo, an isotope of Mo present in natural molybdenum at a percentage of 24.1%.

According to the present invention, a portable generator can be provided that enables the extraction, at hospitals or other use points, of a radiopharmaceutical made from low-specific-activity radioactive molybdenum-99 and of radioactive technetium-99m as a raw material for a labeling compound for the radiopharmaceutical. Under acidic (pH 1 to 5) conditions, Mo (molybdenum-99) is adsorbed onto AC (activated charcoal) or AL (alumina) at a ratio of approximately 1 g (Mo)/5 g (Ac or AL), whereas Tc (technetium-99m) is not adsorbed onto AC or AL. By utilizing these characteristics, the generator serves as a practical portable LSA ⁹⁹Mo/^{99m}Tc generator (TcPG).

The practical application of portable LSA ⁹⁹Mo/^{99m}Tc generators did not progress due to the use of a heavy metal, such as Zr or Ti, as a Mo adsorbent, as well as due to the disadvantage of the ⁹⁸Mo (n, γ) ⁹⁹Mo reaction, in which the starting material is Mo, in that the radioactivity concentration of the resulting ⁹⁹Mo is extremely low compared with when uranium is used. However, in the present invention, the generator is composed of a column that adsorbs ⁹⁹Mo and an AL column that traps and concentrates ^{99m}Tc and does not use a heavy metal, so a Minor Change Notification may be sufficient for approval.

Increasing or reducing the amount of AC that adsorbs Mo (⁹⁹Mo) (e.g., 5 to 30 g/column) according to the specific activity concentration of the Mo (⁹⁹Mo) allows the tank to store a constant amount of ⁹⁹Mo. By eluting ^{99m}Tc derived from ⁹⁹Mo and trapping and concentrating it at the AL column in the second stage, the amount of ^{99m}Tc milked can be controlled.

Even if the specific activity concentration of Mo (⁹⁹Mo) increases or decreases within a certain range, the LSA ⁹⁹Mo/^{99m}Tc generator maintains equivalent ^{99m}Tc production capability.

In the case of conventional portable ⁹⁹Mo/^{99m}Tc generators, a minimum amount of HSA ⁹⁹Mo (a high specific activity of around 10,000 Ci/g (Mo) ) produced through nuclear fission of uranium is adsorbed in a ^{99m}Tc-purifying column, and ^{99m}Tc is eluted from this purifying column using physiological saline.

In the present invention, a Mo (⁹⁹Mo)-absorbing column for allowing grams of LSA Mo (⁹⁹Mo) (a low specific activity of 0.5 Ci/g (Mo) or less) to be adsorbed onto AC or AL and storing ⁹⁹Mo is required upstream of a ^{99m}Tc-purifying column in which AL is disposed. This is because of the overwhelmingly low specific activity (a difference of approximately 10,000 times).

While embodiments of the present invention have been described above, the present invention is not limited thereto. The AC or AL packed in the Mo (⁹⁹Mo)-absorbing column and the ^{99m}Tc -purifying column is not a special type and can be sterilized by high-temperature dry heating or wet heat autoclaving as stipulated in the Minimum Requirements for Radiopharmaceuticals for portable ^{99m}Tc generators.

### REFERENCE SIGNS LIST

100: Mo solution tank
110: Stirrer
120: Cylindrical metal mesh
130: Support
140: Hot cell
150: IER column
160: AL column

1. to 6. (canceled)

7. A method for purifying and recovering medical technetium-99m from low-specific-activity molybdenum-99, the method characterized by comprising separating and recovering daughter nuclide technetium-99m produced through decay of low-specific-activity molybdenum-99 contained in a high-concentration molybdenum solution containing the molybdenum-99, wherein:
activated charcoal or alumina is packed into a cylindrical metal mesh rather than a column, with which a flow rate is limited, in advance, the molybdenum solution is adjusted to a low-pH, acidic state, and then the cylindrical metal mesh is immersed into the molybdenum solution while the molybdenum solution is flowing as a result of being stirred, to prepare a molybdenum-99-adsorbing column, in which the molybdenum-99 has been adsorbed onto the activated charcoal or alumina;
the technetium-99m produced from the molybdenum-99 is eluted from the molybdenum-99-adsorbing column, and an eluate is passed through a technetium-99m-purifying column, packed with weakly acidic alumina, to trap the technetium-99m; and
neutral-pH physiological saline is passed through the technetium-99m-purifying column to separate and elute the technetium-99m, thereby purifying and recovering the technetium-99m while removing impurities.

8. A method for purifying and recovering medical technetium-99m from low-specific-activity molybdenum-99 in which daughter nuclide technetium-99m contained in a high-concentration molybdenum solution containing low-specific-activity molybdenum-99 and produced through decay of the molybdenum-99 is separated and recovered, the method characterized by comprising:
a step of adjusting the molybdenum solution to a low-pH, acidic state, in which adsorption of the molybdenum-99 onto activated charcoal is facilitated, and passing the molybdenum solution through a column container packed with the activated charcoal to cause the molybdenum-99 to be adsorbed and retained on the activated charcoal, thereby preparing a molybdenum-99-adsorbing column in which the molybdenum-99 is stored;
a step of passing low-pH physiological saline, in which the technetium-99m produced from the molybdenum-99 is readily soluble, through the molybdenum-99-adsorbing column and passing the low-pH physiological saline in which the technetium-99m is dissolved through a technetium-99m-purifying column packed with porous weakly acidic alumina to collect the technetium-99m, which is readily trapped by the weakly acidic alumina; and
a step of passing neutral-pH physiological saline through the technetium-99m-purifying column and thus adjusting inside of the technetium-99m-purifying column to a neutral pH to separate and elute the technetium-99m, thereby purifying and recovering the technetium-99m from which impurities have been removed.

9. The method for purifying and recovering medical technetium-99m from low-specific-activity molybdenum-99 as set forth in claim 7, characterized in that the molybdenum solution contains radionuclide molybdenum-99 produced through a neutron capture (n, γ) reaction of natural isotopic molybdenum.

10. The method for purifying and recovering medical technetium-99m from low-specific-activity molybdenum-99 as set forth in claim 7, characterized in that a concentration of the technetium-99m separated and eluted from the molybdenum-99 is changed by increasing or reducing an amount of the activated charcoal or alumina onto which the molybdenum-99 is adsorbed according to a specific activity concentration of the molybdenum-99.

11. A system for purifying and recovering medical technetium-99m from low-specific-activity molybdenum-99, the system characterized by comprising:
means for producing a high-concentration molybdenum solution containing low-specific-activity molybdenum-99 produced through a neutron capture (n, γ) reaction of natural isotopic molybdenum;
means for adjusting the molybdenum solution to a low-pH, acidic state, in which adsorption of the molybdenum-99 onto activated charcoal is facilitated, and passing the molybdenum solution through a column container packed with the activated charcoal to cause the molybdenum-99 to be adsorbed and retained on the activated charcoal, thereby preparing a molybdenum-99-adsorbing column in which the molybdenum-99 is stored;
means for producing daughter nuclide technetium-99m through decay of the molybdenum-99;
means for passing low-pH physiological saline, in which the technetium-99m produced from the molybdenum-99 is readily soluble, through the molybdenum-99-adsorbing column and passing the low-pH physiological saline in which the technetium-99m is dissolved through a technetium-99m-purifying column packed with porous weakly acidic alumina to collect the technetium-99m, which is readily trapped by the weakly acidic alumina; and
means for passing neutral-pH physiological saline through the technetium-99m-purifying column and thus adjusting inside of the technetium-99m-purifying column to a neutral pH to separate and elute the technetium-99m, thereby purifying and recovering the technetium-99m from which impurities have been removed.

12. A molybdenum-99-adsorbing column characterized in that, by packing activated charcoal or alumina into a cylindrical metal mesh rather than a column, with which a flow rate is limited, in advance, adjusting the molybdenum solution to a low-pH, acidic state, and then immersing the cylindrical metal mesh into the molybdenum solution while the molybdenum solution is flowing as a result of being stirred, the molybdenum-99 has been adsorbed onto the activated charcoal or alumina.
